(19) United States
(12) Patent Application Publication
(10) Pub. No.: US 2010/0030606 A1
(43) Pub. Date: Feb. 4, 2010

(54) MISSION SCHEDULING METHOD

(75) Inventors: Soo Jeon Lee, Daejeon-city (KR); Won Chan Jung, Daejeon-city (KR); Jae Hoon Kim, Daejeon-city (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Deajeon-city (KR)

(21) Appl. No.: 12/363,668

(22) Filed: Jan. 30, 2009

(30) Foreign Application Priority Data
Jul. 31, 2008 (JP) 10-2008-0075350

(51) Int. Cl. G06Q 10/00

(52) U.S. Cl. 705/8

(57) ABSTRACT

Provided is a mission scheduling method. The mission scheduling method includes: when a time window representing a time range that a plurality of missions are executed and a duration of the missions are given, determining an execution start time and finish time of each of the missions; selecting a first mission that is first finished among the missions; selecting second missions which collide or do not collide with the first mission depending on the execution order of the second missions; and including in a schedule a mission that is first finished when the first mission and the second missions are respectively executed according to a combination of orders, wherein the first mission and the second missions according to the combination of orders do not collide with each other.

### CROSS-REFERENCE TO RELATED PATENT APPLICATION

This application claims the benefit of Korean Patent Application No. 10-2008-0075350, filed on Jul. 31, 2008 in the Korean Intellectual Property Office, the disclosure of which is incorporated herein in its entirety by reference.

### BACKGROUND OF THE INVENTION

1. Field of the Invention

The present invention relates to a mission scheduling method, and more particularly, to a method of including a number of various missions in a schedule within a given time.

2. Description of the Related Art

Studies on mission scheduling can be classified into four types according to the number of resources and whether slack, namely, idle time is allowed or not; the four types are: <single resource, slack allowed>, <single resource, slack not allowed>, <multiple resources, slack allowed>, and <multiple resources, slack not allowed>. Multiple resources are a more complicated problem than single resource, and it is a more complicated problem when slack is allowed than when slack is not allowed. However, the complexity is more affected by whether slack is allowed or not than by the number of resources. The number of resources has only a polynomial time complexity, but the allowed slack has an exponential time complexity.

When slack is not allowed, an optimal timeline is calculated within a polynomial time regardless of the number of resources.

However, if slack is allowed, a problem that generates an optimal timeline regardless of the number of resources becomes a nondeterministic polynomial (NP)-Complete problem. In other words, it is impossible to generate an optimal timeline using a mission scheduling algorithm (MSA) when the size of the problem is slightly big. In this case, one should be satisfied with generating a near optimal time line within a shortest time. To this end, various heuristics including a random sampling algorithm have been used.

### SUMMARY OF THE INVENTION

The present invention provides a mission scheduling method in which a number of missions are executed within a limited time in the case of a single resource when slack is allowed.

According to an aspect of the present invention, there is provided a mission scheduling method, the method comprising: when a time window representing a time range wherein a plurality of missions are executed and a duration of the missions are given, determining execution start time and finish time of each of the missions; selecting a first mission that is first finished among the missions; selecting second missions which collide or do not collide with the first mission depending on the execution order of the second missions; and including in a schedule a mission that is first finished when the first mission and the second missions are respectively executed according to a combination of orders, wherein the first mission and the second missions according to the combination of orders do not collide with each other.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a mission operating system for a satellite to which an embodiment of the present invention is applied and the satellite performing missions according to a schedule of the mission operating system; and

FIGS. 2A and 2B illustrate processes of scheduling of multiple missions according to embodiments of the present invention.

### DETAILED DESCRIPTION OF THE INVENTION

The present invention will now be described more fully with reference to the accompanying drawings, in which exemplary embodiments of the invention are shown.

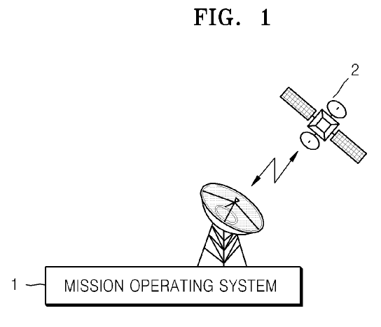

FIG. 1 is a schematic view illustrating a mission operating system 1 of a satellite to which an embodiment of the present invention is applied and the satellite performing missions according to a schedule of the mission operating system.

The mission operating system 1 executes a mission scheduling method according to an embodiment of the present invention, to operate missions with respect to a satellite 2. That is, the mission operating system 1 creates a mission plan and a timeline based on information on the satellite orbit and attitudes, according to the demand of the user who uses the satellite 2, and schedules missions in consideration of whether the missions collide with each other and priorities of the missions.

A program code syntax with respect to the mission scheduling method according to the current embodiment of the present invention that is executed in the mission operating system 1 is as follows.

```
def adt_pceb(req):
  finish_time=0
  sched=Schedule( )
  while True:
    req=gen(req, finish_time)
    if len(req)==0:
      break
    sort_by_finish_time(req)
    finish_time=req[0].F
    for t in req[1:]:
      if t.F_w-t.D<=finish_time and t.F<req[0].F_w-req[0].D:
        selected_later_F=t.F+req[0].D
        req2=gen(req[1:], finish_time)
        req2.remove(t)
        if len(req2)==0:
          finish_time=t.F
          sched.append(t)
          req.remove(t)
          break
        elif req2[0].F > selected_later_F:
          finish_time=t.F
          sched.append(t)
          req.remove(t)
          break
        else:
          sched.append(req[0])
          req.remove(req[0])
        break
    else:
      sched.append(req[0])
      req.remove(req[0])
      return sched
def gen(req, finish_time):
  req_list=[ ]
  for t in req:
    if finish_time <= t.S_w:
      t.S=t.S_w
      t.F=t.S_w+t.D
      req_list.append(t)
    elif finish_time+t.D<=t.F_w:
      t.S=finish_time
        t.F=finish_time+t.D
      req_list.append(t)
  return req_list
```

Assume a time range, namely a time window during which mission t can be executed, is referred to as [t.S_w, t.F_w]. Since an actual start time t.S and a finish time t.F of mission t should be within the time window in this case, t.S_w≦t.S<t.F <t.F_w is established. Mission duration t.D of the mission t is equal to t.F−t.S. Slack, which is a spare period of the mission t within the time window, is denoted as t.Slack, and t.Slack=t.F_w−t.D−t.S_w. An ID of the mission t is t.ID.

According to the above-described program code, a satellite mission scheduling algorithm of the present invention includes a mission list generating function gen() and a mission scheduling function adt_pceb().

First, the adt_pceb function adt_pceb() will the described. A mission request list, req, is received as an input parameter, wherein req includes a request of a user who is willing to use a satellite resource. That is, req is equal to a set of multiple missions. Each mission t includes six pieces of information, that is, t.ID, t.S_w, t.F_w, t.D, t.S, and t.F. However, in a request operation, t.S and t.F are not determined, and values of t.ID, t.S_w, t.F_w, and t.D are input. Thus, it is the role of scheduling to determine t.S and t.F.

When the adt_pceb function is executed, finish_time is initialized to 0, and sched is initialized to an empty schedule to which no mission is allocated yet. Missions selected thereafter are added one by one to sched, and when the algorithm is finished, the selected missions are returned as the results of scheduling. Also, finish_time stores a finish time of a mission that is most recently added to sched, that is, t.F.

Then, a while loop is executed repeatedly. First, the gen function is called in the wile loop.

The gen function selects executable ones among the mission requests in the req and stores them in req_list. The gen function will be described below for each process.

First, req_list is initialized to an empty list. In the gen function, t.S is adhered as closely as possible to the beginning part of the time window. That is, after examining the mission t corresponding to a current req, when a currently set finish_time is smaller than or equal to t.S_w, the mission t can be executed from the very front of the time window. Accordingly, t.S and t.F of the mission t are set as t.S_w and t.S_w+t.D, and the mission t is added to req_list.

If the currently set finish_time+t.D is smaller than or equal to t.F_w, the mission t can be executed within the time window, but t.S needs to be set to be after finish_time so that no collision occurs between the mission t and a mission that is recently added to sched. Accordingly, t.S and t.F of the mission t are respectively set as finish_time and finish_time+t.D, and the mission t is added to req_list.

If the mission t does not correspond to any one of the above-described two cases, the mission t collides with a mission that is recently added to sched, thus cannot be executed within the corresponding time window of the mission t and is not added to req_list. After the above operations are conducted with respect to all missions of req, the gen function is finished.

When the gen function is finished and req_list is returned, the algorithm returns again to the adt_pceb function. If the return value from the gen function, that is, the length of updated req, is 0, there is no mission to be added and thus the algorithm left out of loop and is finished.

When the length of req is not 0, the missions of req are arranged in an ascending order of their finish times. Next, the finish time of a mission req[0] whose finish time is earliest is set as finish_time.

Then, during a for loop execution, other missions within req[0] and req, that is, req[1], req[2], . . . , etc., are sequentially compared. Here, assume another mission which is an object of comparison is referred to t.

For example, when t collides with req[0] (that is, t.F_w−t.D<=finish_time) but req[0] can only be executed after executing the mission t first (that is, t.F<req[0].F_w−req[0].D), t.F+req[0].D is stored in selected_later_F. Then the results of the gen function performed with respect to requests other than req[0] in req, that is, req[1:] and finish_time, are stored in req2.

If req2 is empty, the mission t needs to be executed first, and thus the mission t is added to the schedule sched (finish_time=t.F, sched.append(t)), and the mission t is removed from req and returns to the beginning of the while loop. If req2 is not empty and req2[0].F is greater than selected_later_F, that is, if the finish time of execution of req[0] after performing the mission t is shorter than the finish time of the execution of req2[0], the mission t needs to be executed first. Thus the mission t is selected instead of req[0] and added to the schedule sched (finish_time=t.F, sched.append(t)), and the mission t is removed from req and then the algorithm returns again to the beginning of while loop.

When the finish time of execution of req[0] after the execution of the mission t is not shorter than the finish time of the execution of req2[0], it is not appropriate to execute the mission t. Thus req[0] is added to the schedule sched instead of the mission t (sched.append(req[0])), and req[0] is removed from req and the algorithm returns again to the beginning of the while loop.

If a mission t does not collide with req[0] (that is, t.F_w−t.D>finish_time) or it is not appropriate to execute req[0] after executing the mission t first (that is, t.F>=req[0].F_w−req[0].D), req[0] is added to the schedule sched instead of the mission t, and req[0] is removed from req and the algorithm returns again to the beginning of while loop.

When the while loop is finished, the adt_pceb function is finished, and the schedule sched is returned as the result of scheduling.

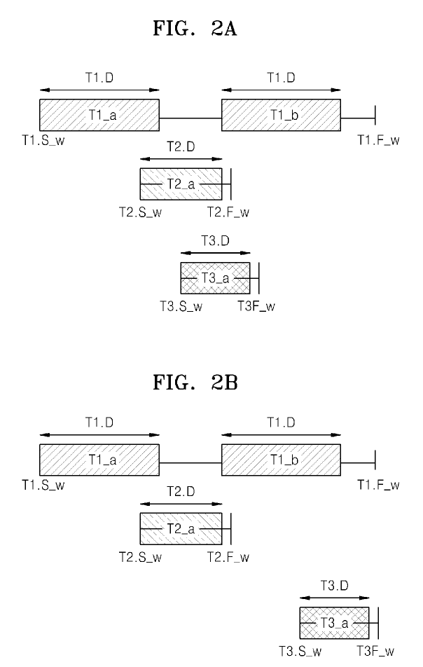

FIGS. 2A and 2B illustrate scheduling processes of multiple missions according to embodiments of the present invention.

First, it is assumed that only two missions T1 and T2 are present in FIG. 2A. In this case, T1 basically needs to be executed at the position T1_a. T2 is omitted from the schedule due to T1. However, if T1 is not executed at T1_a and T2 is first executed at the position T2_a, it is probable that T1 is executed at T1_b after T2. In this manner, two missions T2 and T1 may be expected to be executed, unlike the case where only one mission, the mission T1, is executed.

Here, a case where another mission T3 other than T1 and T2 is present will be considered. Two missions T2_a and T1_b are executed in the above-described method and the final finish time is T1_b.F.

On the other hand, when T1_a is selected, even if T2 is omitted, T3 which is executed at a position T3_a can be selected. As a result, two missions T1_a and T3_a are executed, and the final finish time is T3_a.F.

Consequently, even if both of the above-described two methods execute two missions, it is preferable to select T1_a and T3_a in terms of executing a schedule as quickly as possible, because T3_a.F<T1_b.F.

According to the above-described method, it is more preferable to select T2_a and T1_b in the embodiment of FIG. 2B than to select T1_a and T3_a. Accordingly, according to the current embodiment of the present invention, an improved result can be obtained in both embodiments illustrated in FIGS. 2A and 2B compared to the conventional art.

According to the mission scheduling method of the present invention, it is checked whether a mission that is selected because it can be finished as the first and another mission that is to be omitted due to the selected mission may coexist. If there is probability of coexistence, it is judged whether it is more advantageous to include the mission to be omitted instead of the selected mission. If it is advantageous to include the mission to be omitted, the mission to be omitted is included in the schedule, and if it is not advantageous, the selected mission is included in the schedule. Thus, further missions can be executed within a limited time compared with the conventional art.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

In alternative embodiments, hard-wired circuitry may be used in place of or in combination with processor/controller programmed with computer software instructions to implement the invention. Thus embodiments of the invention are not limited to any specific combination of hardware circuitry and software.

As described above, preferred embodiments of the present invention have been described with reference to the attached drawings. The meaning of the terms used in the present specification and claims of the present invention should not be limited to be of ordinary or literary meaning but construed as meanings and concepts not departing from the spirit and scope of the invention. Accordingly, it will be understood by those skilled in the art that various changes in form and details may be made therein without departing from the spirit and scope of the invention as defined by the appended claims. Therefore, the scope of the invention is defined not by the detailed description of the invention but by the appended claims.

What is claimed is:

1. A mission scheduling method, the method comprising:
when a time window representing a time range wherein a plurality of missions are executed and a duration of the missions are given, determining execution start time and finish time of each of the missions;
selecting a first mission that is first finished among the missions;
selecting second missions which collide or do not collide with the first mission depending on the execution order of the second missions; and
including in a schedule a mission that is first finished when the first mission and the second missions are respectively executed according to a combination of orders, wherein the first mission and the second missions according to the combination of orders do not collide with each other.

2. The method of claim 1, wherein when a finish time of a previous mission is earlier than or the same as a time window start time of a current mission, an execution start time of the current mission is set as the time window start time of the current mission and the finish time of the previous mission is set as the sum of the time window start time of the current mission and a duration of the current mission.

3. The method of claim 2, wherein when the sum of the finish time of the previous mission and the duration of the current mission is earlier than or equal to a finish time of the time window of the current mission, the finish time of the previous mission is set as the start time of the current mission, and the sum of the finish time of the previous mission and the duration of the current mission is set as the finish time of the current mission.

4. The method of claim 1, wherein in the determining of an execution start time and finish time of each mission, when the sum of a finish time of a previous mission and a duration of a current mission deviates the time window of the current mission, the current mission is omitted.

5. The method of claim 1, wherein whether the first mission collides with any one of the second missions is checked by examining whether a time of subtracting a duration of the second mission from the finish time of the time window of the second mission is earlier than or equal to the finish time of the first mission.

6. The method of claim 1, wherein the selecting of the second missions which do not collide with the first mission is conducted by judging whether the finish time of the second missions is earlier than a time of subtracting a duration of the first mission from the finish time of the time window of the first mission.

7. The method of claim 1, wherein when a collision occur by conducting the first mission before any one of the second missions, and when a collision does not occur by conducting the second mission before the first mission, and when there is no third mission to be executed or when sequential finish times of the second missions and the first mission are shorter than an execution finish time of the third mission, then the second missions are included in the schedule.

8. The method of claim 7, wherein when the sequential finish times of the second missions and the first mission are not shorter than the execution finish time of the third mission, the first mission is included in the schedule.
